(19) United States
(12) Patent Application Publication
(10) Pub. No.: US 2008/0120811 A1
(43) Pub. Date: May 29, 2008

(54) Adjustable hinge

(76) Inventor: Ting-Hsien Wang, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/604,868

(22) Filed: Nov. 28, 2006

(51) Int. Cl. E05D 7/00

(52) U.S. Cl. 16/386

(57) ABSTRACT

A hinge has a shaft, an adjusting nut, a stationary bracket and a rotating bracket and is mounted in an electronic appliance that has a cover and a base. The shaft has an adjusting thread. The adjusting nut is screwed onto the adjusting thread of the shaft. The stationary bracket connects to the base of the electronic appliance and is attached securely to the shaft. The rotating bracket connects to the cover of the electronic appliance and is mounted around the shaft. Moving the adjusting nut along the adjusting thread pushes the rotating bracket. Therefore, the distance between the rotating bracket and the stationary bracket is adjusted and the position of the rotating bracket and the stationary bracket easily align with the assembling position in the cover and the base of the electronic appliance.

### BACKGROUND OF THE INVENTION

1. Field of the Invention

The present invention relates to a hinge, especially to a hinge is mounted in an electrical appliance to allow a cover of the electrical appliance rotating in relative to a base of the electrical appliance.

2. Description of the Prior Arts

Electrical appliances such as notebook computers, cell phones, etc. have a cover, a base and a conventional hinge. The conventional hinge connects the cover to the base to allow the cover to pivot relative to the base. The conventional hinge comprises a shaft, a stationary bracket, a rotating bracket, a spacer assembly and a fastener. The stationary bracket, the rotating bracket and the spacer assembly are mounted around the shaft. The fastener is mounted securely on an end of the shaft to hold all the components. The stationary bracket connects to the base of the electronic appliance. The rotating bracket connects to the cover of the electronic appliance. The base and the cover respectively have a predetermined place to connect to the stationary bracket and the rotating bracket. Therefore, the distance between the stationary bracket and the rotating bracket must be constant to correspond to the distance between the predetermined places in the base and the cover. However, with the inaccuracy of the stationary bracket and the rotating bracket, the distance between the stationary bracket and the rotating bracket is not easy to be constant. Thus the distance between the stationary bracket and the rotating bracket need to be adjusted.

To overcome the shortcomings, the present invention provides an adjustable hinge to mitigate or obviate the aforementioned problems.

### SUMMARY OF THE INVENTION

The main objective of the present invention is to provide an adjustable hinge. The hinge has a shaft, an adjusting nut, a stationary bracket and a rotating bracket and is mounted in an electronic appliance that has a cover and a base. The shaft has an adjusting thread. The adjusting nut is screwed onto the adjusting thread of the shaft. The stationary bracket connects to the base of the electronic appliance and is attached securely to the shaft. The rotating bracket connects to the cover of the electronic appliance and is mounted around the shaft. Moving the adjusting nut along the adjusting thread pushes the rotating bracket. Therefore, the distance between the rotating bracket and the stationary bracket is adjusted and the position of the rotating bracket and the stationary bracket easily align with the assembling position in the cover and the base of the electronic appliance.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is another exploded perspective view of the hinge in FIG. 1;

FIG. 4 is a side view of the hinge in FIG. 1; and

FIG. 5 is an operational side view of the hinge in FIG. 1.

### DETAILED DESCRIPTION OF THE PREFERRED EMBODIMENTS

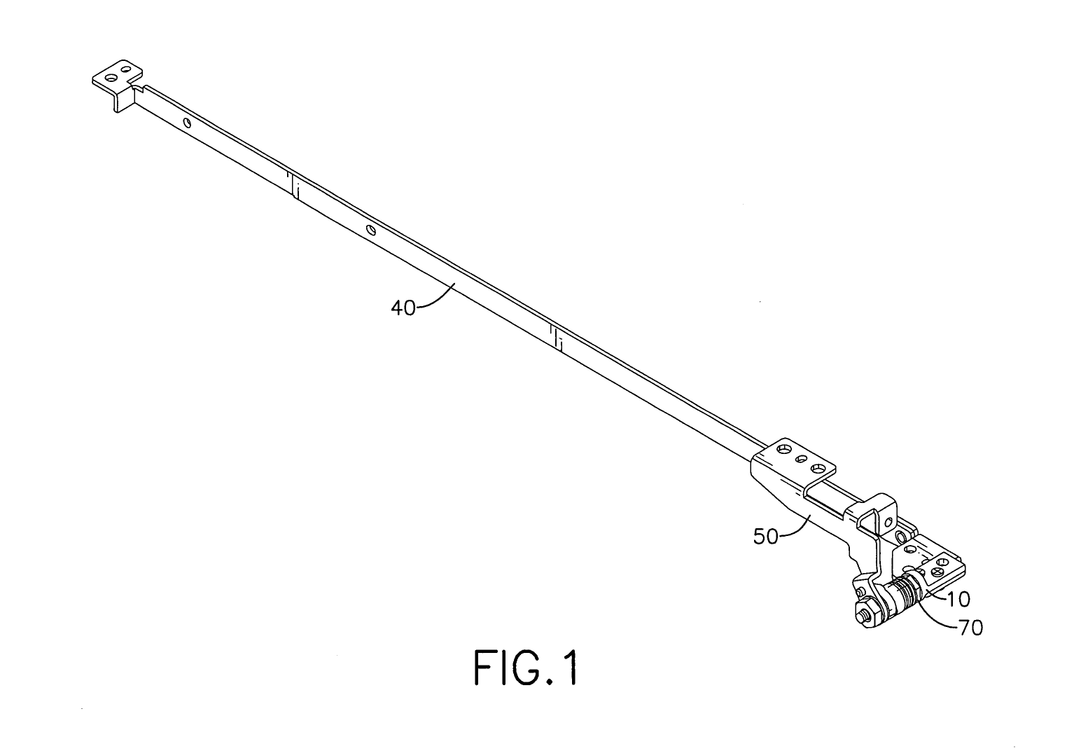

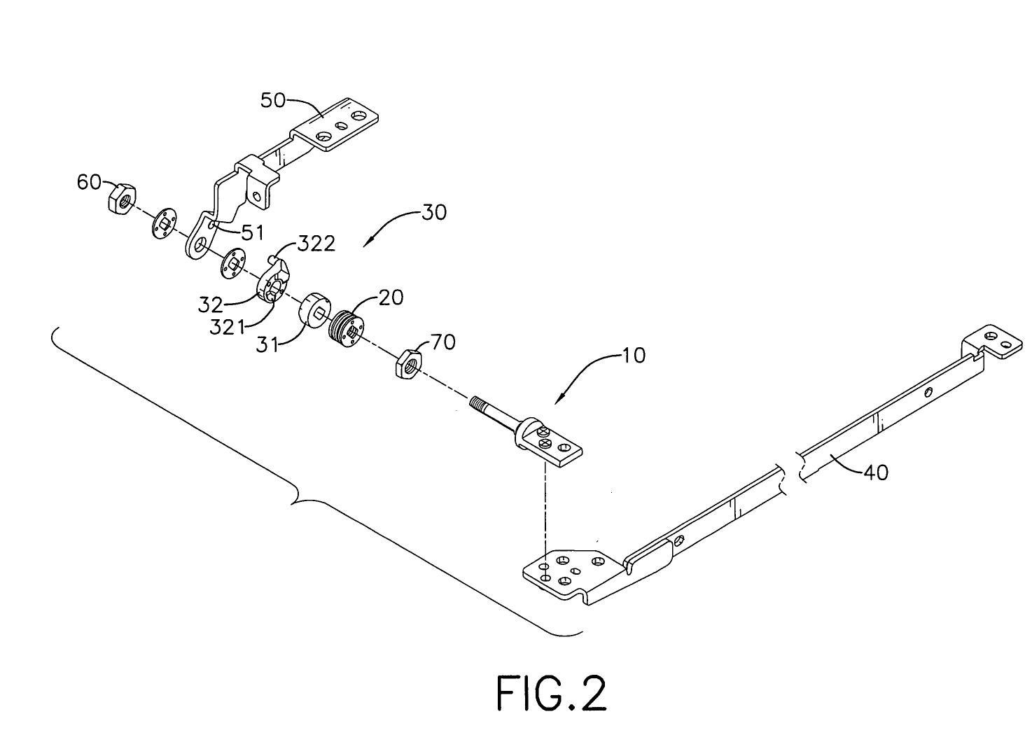

With reference to FIGS. 1 and 2, a hinge in accordance with the present invention comprises a shaft (10), an adjusting nut (70), a biasing member (20), a spacer assembly (30), a stationary bracket (40), a rotating bracket (50) and a fastener (60).

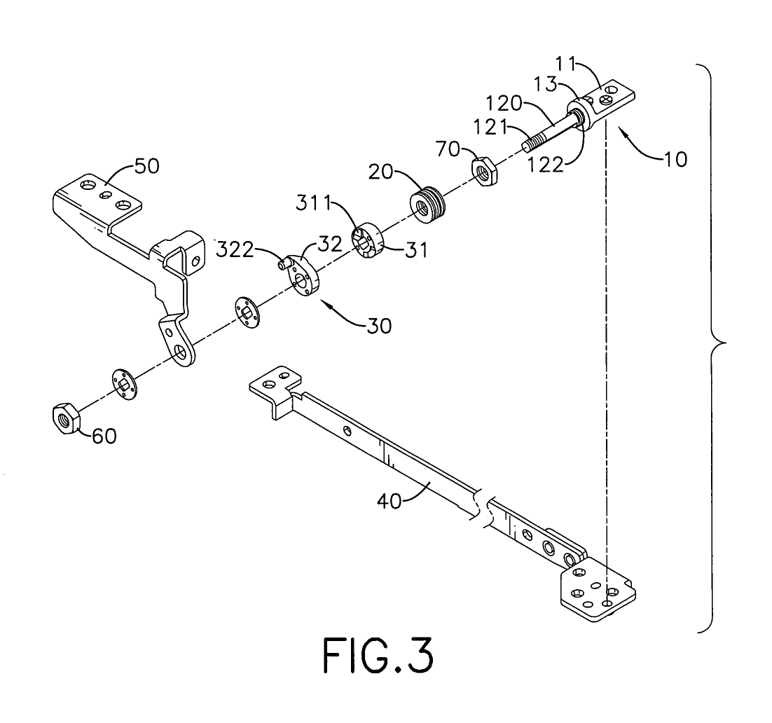

With further reference to FIG. 3, the shaft (10) has fastening rod (11), an extension rod (12) and a head (13). The fastening rod (11) has a distal end and a proximal end. The extension rod (12) is non-circular in cross section, is formed axially on the proximal end of the fastening rod (11) and has a distal end, a proximal end, a fastening thread (121) and an adjusting thread (122). The proximal end of the extension rod (12) connects to the proximal end of the fastening rod (11). The fastening thread (121) is formed around the extension rod (12) adjacent to the distal end of the extension rod (12). The adjusting thread (122) is formed around the extension rod (12) adjacent to the proximal end of extension rod (12). The head (13) is formed radially between the fastening rod (11) and the extension rod (12).

The adjusting nut (70) is screwed on the adjusting thread (122) of the extension rod (12).

The biasing member (20) is mounted around the extension rod (12) and abuts the adjusting nut (70).

The spacer assembly (30) is mounted around the extension rod (12) adjacent to the biasing member (20) and comprises a stationary positioning spacer (31) and a rotating positioning spacer (32). The stationary positioning spacer (31) is mounted securely on the extension rod (12) and has a non-circular central hole, a contacting surface and at least one positioning detent (311). The non-circular central hole of the stationary positioning spacer (31) is mounted securely on the non-circular extension rod (12). The positioning detent (311) is formed in the contacting surface of the stationary positioning spacer (31). The rotating positioning spacer (32) is mounted around the extension rod (12) adjacent to the stationary positioning spacer (31) and has a contacting surface, a fastening surface, at least one positioning protrusion (321) and a fastening protrusion (322). The contacting surface of the rotating positioning spacer (32) rubs against the contacting surface of the stationary positioning spacer (31). The fastening surface of the rotating positioning spacer (32) is opposite to the contacting surface of the stationary positioning spacer (31). The at least one positioning protrusion (321) is formed in the contacting surface of the rotating positioning spacer (32) and corresponds to and selectively engages the at least one positioning detent (311) of the stationary positioning spacer (31) to provide positioning function. The fastening protrusion (322) is formed on the fastening surface of the rotating positioning spacer (32).

The stationary bracket (40) is attached securely to the fastening rod (11) of the shaft (10).

The rotating bracket (50) is mounted around the extension rod (12) between the fastening thread (121) and the adjusting thread (122), is attached securely to the rotating positioning spacer (32) and has a fastening hole (51). The fastening hole (51) is formed through the rotating bracket (50) and is mounted securely on the fastening protrusion (322) of the rotating positioning spacer (32) to attach the rotating bracket (50) securely to the rotating positioning spacer (32).

The fastener (60) is mounted securely on the distal end of the extension rod (12) and may be a nut screwed onto the fastening thread (121) on the extension rod (12).

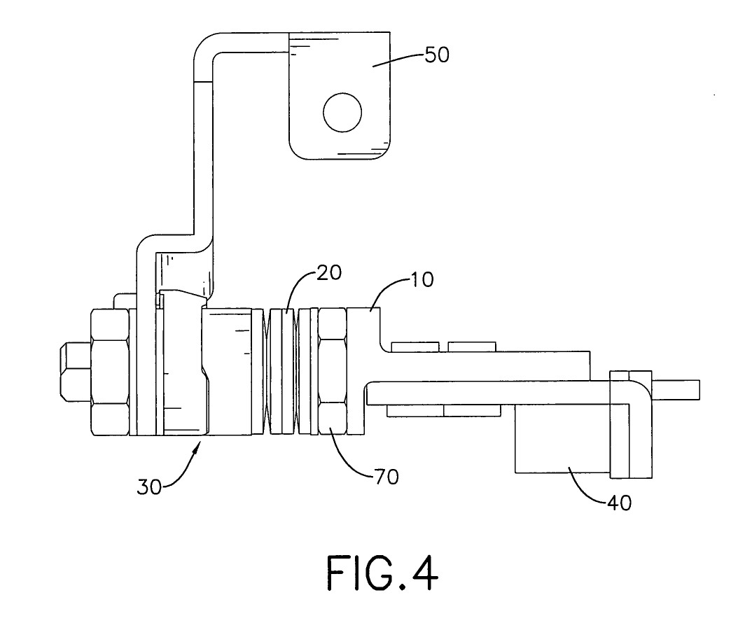

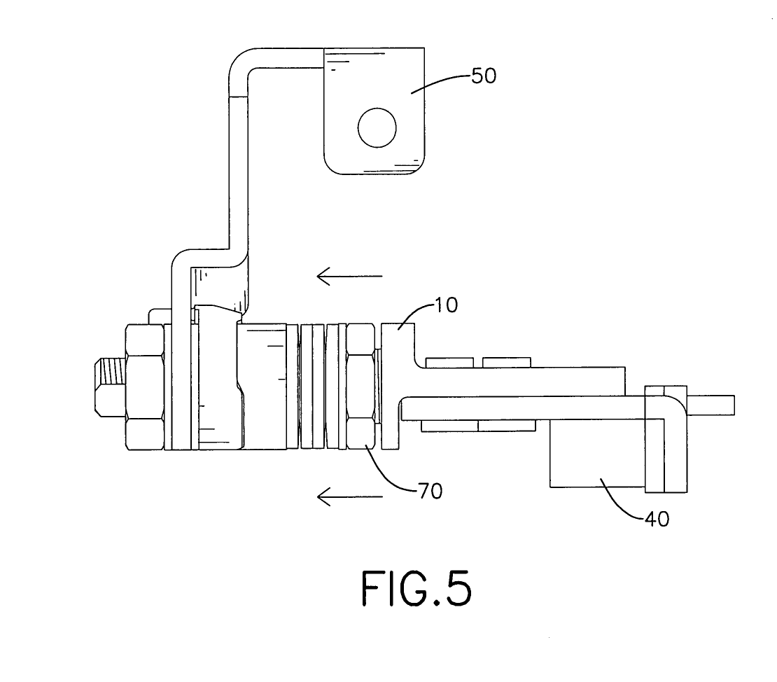

With further reference to FIGS. 4 and 5, the hinge as described is mounted in an electronic appliance that has a cover and a base. The rotating bracket (50) connects to the cover of the electronic appliance. The stationary bracket (40) connects to the base of the electronic appliance. When the adjusting nut (70) moves along the adjusting thread (122) of the shaft (10), the adjusting nut (70) presses the biasing member (20) and the spacer assembly (30) to push the rotating bracket (50). Therefore, the distance between the rotating bracket (50) and the stationary bracket (40) is adjusted by moving the adjusting nut (70) along the adjusting thread (122) of the shaft (10) to easily align with the assembling position in the cover and the base of the electronic appliance.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. The hinge comprising:
a shaft having
a fastening rod;
an extension rod extending axially from the fastening rod; and
an adjusting thread formed around the extension rod adjacent to the fastening rod;
an adjusting nut screwed onto the adjusting thread of the shaft;
a biasing member mounted around the extension rod;
a spacer assembly mounted around the extension rod;
a stationary bracket attached to the fastening rod;
a rotating bracket mounted around the extension rod between a distal end of the extension rod and the adjusting thread; and
a fastener mounted securely on the distal end of the extension rod.

2. The hinge as claimed in claim 1, wherein
the shaft further has a fastening thread formed around the extension rod adjacent to the distal end of the extension rod; and
the fastener is a nut screwed onto the fastening thread of the shaft.

3. The hinge as claimed in claim 1, wherein the spacer assembly comprises
a stationary positioning spacer mounted securely on the extension rod and having
a contacting surface; and
at least one positioning detent formed in the contacting surface of the stationary positioning spacer; and
a rotating positioning spacer mounted around the extension rod adjacent to the stationary positioning spacer and having
a contacting surface; and
at least one positioning protrusion formed in the contacting surface of the rotating positioning spacer and corresponding to and selectively engaging the at least one positioning detent of the stationary positioning spacer.

4. The hinge as claimed in claim 2, wherein the spacer assembly comprises
a stationary positioning spacer mounted securely on the extension rod and having
a contacting surface; and
at least one positioning detent formed in the contacting surface of the stationary positioning spacer; and
a rotating positioning spacer mounted around the extension rod adjacent to the stationary positioning spacer and having
a contacting surface; and
at least one positioning protrusion formed in the contacting surface of the rotating positioning spacer and corresponding to and selectively engaging the at least one positioning detent of the stationary positioning spacer.

5. The hinge as claimed in claim 3, wherein
the extension rod is non-circular in cross section; and
the stationary positioning spacer has a non-circular central hole mounted securely on the extension rod.

6. The hinge as claimed in claim 4, wherein
the extension rod is non-circular in cross section; and
the stationary positioning spacer has a non-circular central hole mounted securely on the extension rod.

7. The hinge as claimed in claim 3, wherein
the rotating positioning spacer has
a fastening surface being opposite to the contacting surface of the rotating positioning spacer; and
a fastening protrusion formed on the fastening surface of the rotating positioning spacer; and
the rotating bracket has a fastening hole formed through the rotating bracket and mounted securely on the fastening protrusion of the rotating positioning spacer.

8. The hinge as claimed in claim 6, wherein
the rotating positioning spacer has
a fastening surface being opposite to the contacting surface of the rotating positioning spacer; and
a fastening protrusion formed on the fastening surface of the rotating positioning spacer; and
the rotating bracket has a fastening hole formed through the rotating bracket and mounted securely on the fastening protrusion of the rotating positioning spacer.

9. The hinge as claimed in claim 1, wherein the shaft further comprises a head formed radially between the fastening rod and the extension rod.

10. The hinge as claimed in claim 8, wherein the shaft further comprises a head formed radially between the fastening rod and the extension rod.
